(19) United States
(12) Patent Application Publication
(10) Pub. No.: US 2001/0048748 A1
(43) Pub. Date: Dec. 6, 2001

(54) RECEIVER/TRANSMITTER FOR USE WITH AN AUDIO SYSTEM FOR BROADCASTING AUDIO SIGNALS

(76) Inventor: JOHN M. VAN RYZIN, MADISON, NJ (US)

Correspondence Address: FROMMER LAWRENCE & HAUG, 745 FIFTH AVENUE- 10TH FL., NEW YORK, NY, 10151, US

(21) Appl. No.: 09/033,445

(22) Filed: Mar. 2, 1998

(51) Int. Cl. H04H 5/00

(52) U.S. Cl. 381/2

(57) ABSTRACT

A receiver/transmitter for use in an audio system having a reproducing device for providing reproduced audio signals and located in a home or office. The receiver/transmitter may be operable in a number of modes in which one of such modes enables reproduced audio signals to be transmitted over a broadcast frequency for reception by a wireless receiver tuned to the broadcast frequency and located in a different location of the home or office from that of the receiver/transmitter. Such wireless receiver may be a portable type radio receiver or a stationary type radio receiver. As a result, an operator may listen to a desired portion of a compact disc or tape or the like which is being reproduced by the reproducing device in one room or portion of the home or office while the operator is in a different room or portion of the home or office or while the operator is moving between rooms or portions of the home or office.

### BACKGROUND OF THE INVENTION

The present invention relates to an audio system for use in a home or office and, more particularly, to such system having a transmitting unit for broadcasting reproduced audio signals over a selected broadcast frequency so as to be received by a radio-type receiver also located in or in close proximity to the home or office.

An audio system for use in a home or office may include a receiver, a number of audio reproducing units (such as a compact disc player, a tape cassette player, and so forth), and a plurality of speakers. For example, as shown in FIG. 1, an audio system 8 may include a receiver 10 coupled to speakers 12 by way of wires or cables 18 and further coupled to a compact disc (CD) player 14 and a tape player 16 by way of wires or cables 20 and 22, respectively. The receiver 10 may receive audio signals from a remote broadcasting station, process such signals, and supply the processed signals to the speakers by way of the cables 18 so as to enable an operator to hear the same. Additionally, the receiver 10 may receive reproduced audio signals from the CD player 14 and/or the tape player 16 by way of the cables 20/22, process such received signals, and supply the processed audio signals to the speakers 12 by way of the cables 18. In this latter situation, the audio system 8 enables a desired track or portion of a compact disc or a tape to be reproduced by using the receiver 10 and the CD player 14 or tape player 16 and supplied to the speakers 12 so that an operator may listen to the desired portion of the compact disc or tape.

The audio system 8 is typically located in one room of a home of office. As is to be appreciated, an operator would normally have to be in such room, or in close proximity thereto, in order to hear the desired portion of the compact disc or tape. Accordingly, if the operator wished to listen to the desired portion of the compact disc or tape from another room or part of the home or office by using the audio system 8 in its current location, the operator would probably be unable to do so. To enable the operator to listen to the desired portion of the compact disc or tape in this situation, the operator may need either a second audio system having a CD player and/or a tape player or remote speakers coupled to the first audio system. As is to be appreciated, both of the these alternatives may be costly and/or difficult to install. For example, it may be difficult to connect the receiver of the audio system 8 to the new remote speakers. Additionally, if the operator wished to listen to the desired portion of the compact disc or tape while moving between rooms or parts of the home or office, the operator may be unable to do so even with the use of a second audio system or new remote speakers.

Accordingly, it may be desirable to provide an audio system for use in a home or office having a CD player and/or a tape player or the like which enables an operator to listen to a desired track or portion of a compact disc or tape or the like while in a location different from that of the audio system or while moving throughout the home or office.

### OBJECTS AND SUMMARY OF THE INVENTION

An object of the present invention is to provide an audio system located in a first location of a home or office and having a CD player and/or a tape player or the like which enables an operator to listen to a desired portion of a compact disc or tape or the like in a second location of the home or office.

Another object of the present invention is to provide an audio system as aforesaid in which audio signals reproduced from the CD player and/or tape player are broadcasted over a selected broadcast frequency for reception by a wireless receiver located in a second location of the home or office.

A yet further object of the present invention is to provide an audio system as aforesaid in which the broadcast frequency is selected from among a plurality of FM (frequency modulated) frequencies.

A still further object of the present invention is to provide an audio system as aforesaid in which the wireless receiver is a portable-type wireless receiver adaptable to be easily carried by the operator so as to enable the operator to listen to the desired portion of the compact disc or tape while moving between rooms or parts of the home or office.

According to an aspect of the present invention, an audio system for use in a home or office is provided which comprises a reproducing unit, located in a first location of the home or office, for reproducing audio signals from a storage medium; and a receiver/transmitter unit coupled to the reproducing unit and having means for enabling an operator to select a desired broadcasting frequency from among a plurality of broadcast frequencies, in which the receiver/transmitter unit receives the reproduced audio signals from the reproducing unit and broadcasts the received audio signals over the selected broadcast frequency for reception by a second receiver unit located in a second location of the home or office.

Other objects, features and advantages according to the present invention will become apparent from the following detailed description of illustrated embodiments when read in connection with the accompanying drawings in which corresponding components are identified by the same reference numerals.

### BRIEF DESCRIPTION OF THE DRAWINGS

FIG. 1 is a diagram of an audio system;

FIG. 2 is a diagram of an audio system according to an embodiment of the present invention; and

FIG. 3 is diagram of a receiver/transmitter unit of the audio system of FIG. 2.

### DESCRIPTION OF THE PREFERRED EMBODIMENTS

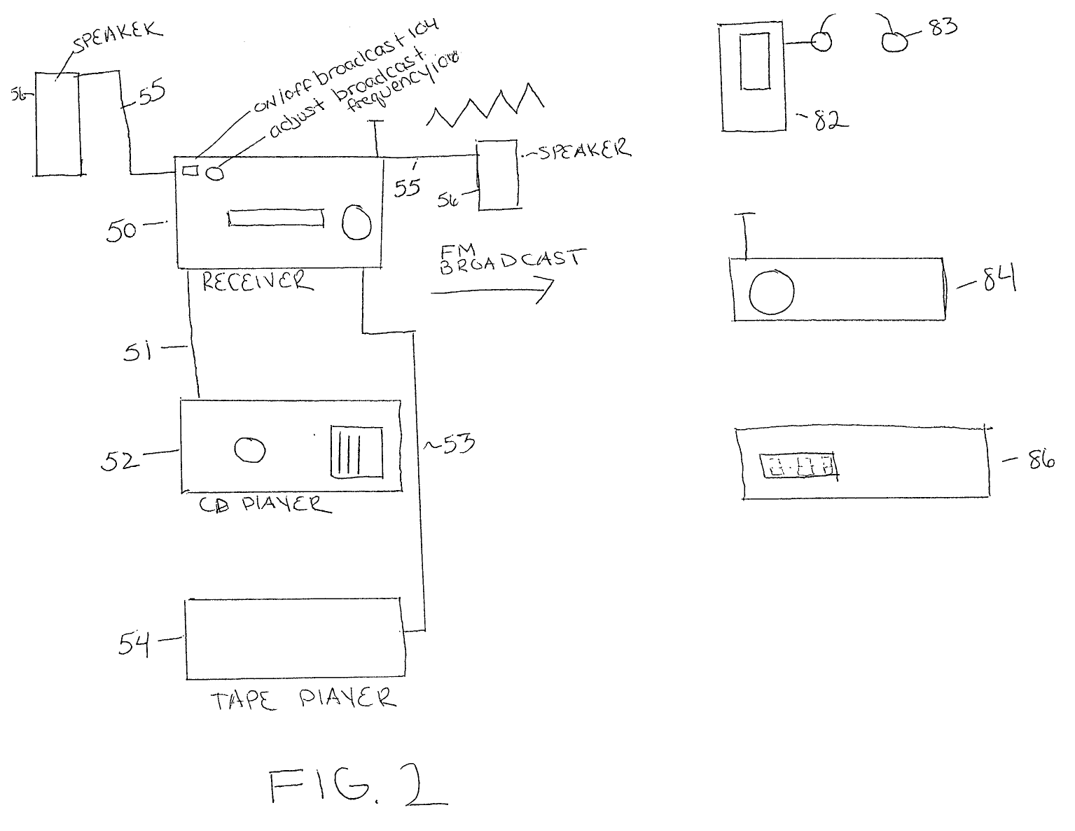

FIG. 2 illustrates an audio system 99 for use in a home or office or the like which includes a receiver/transmitter 50, a CD player 52, a tape player 54, and speakers 56. As shown therein, the receiver/transmitter 50 is coupled to the CD player 52 by way of a wire(s) or cable(s) 51, to the tape player 54 by way of a wire(s) or cable(s) 53, and to the speakers 56 by way of wires or cables 55.

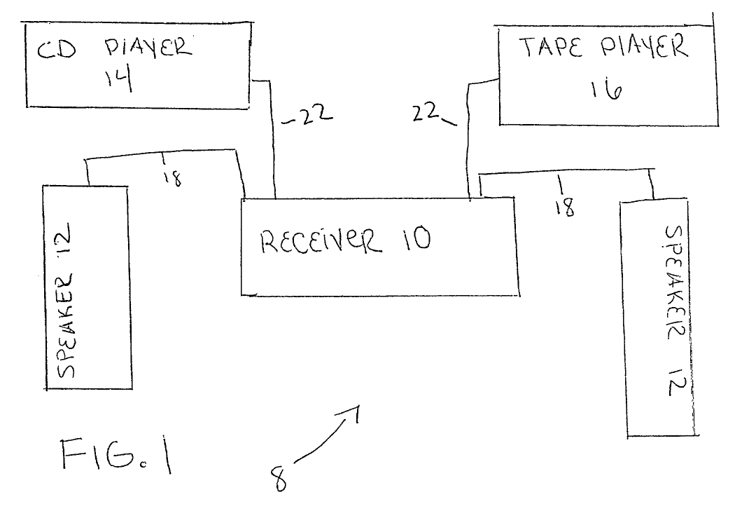

In a manner similar to that of the receiver 10 of the audio system 8 of FIG. 1, the receiver/transmitter 50 may receive audio signals from a remote broadcasting station, process such signals, and supply the processed signals to the speakers by way of the cables 55; and, the receiver/transmitter 50 may receive reproduced audio signals from the CD player 52 and/or the tape player 54 by way of the cables 51/53, process such received signals, and supply the processed audio signals to the speakers 56 by way of the cables 55. In this latter situation, the audio system 99 enables a desired track or portion of a compact disc or a tape to be reproduced by using the receiver/transmitter 50 and the CD player 52 or tape player 54 and supplied to the speakers 56 so that an operator may listen to the desired portion of the compact disc or tape.

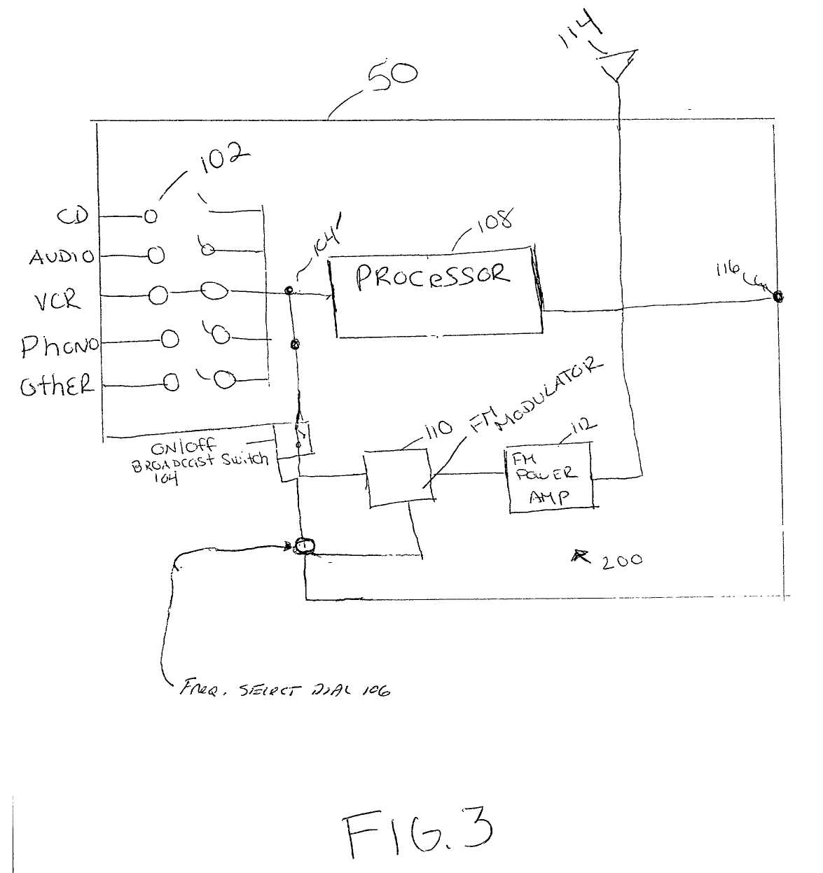

Unlike the receiver 10 of the audio system 8 of FIG. 1, the receiver/transmitter 50 includes a transmitting circuit 200, as illustrated in FIG. 3. The transmitting circuit 200 is adapted to transmit audio signals reproduced by a reproducing device over a selected FM frequency for reception by a wireless receiver located in, or in close proximity to, the home or office wherein the audio system 99 is located. The transmitting circuit 200 may include an on/off broadcast switch 104, a frequency select dial 106, an FM modulator 110, and an FM power amplifier 112 which may be coupled together as shown in FIG. 3.

Accordingly, the receiver/transmitter 50 may function in a first mode in which received audio signals are merely processed and outputted for supply to the speakers 56 (FIG. 2) and/or in a second mode in which the received audio signals are processed and transmitted over a selected frequency. Such first and second modes will now be more fully described hereinbelow. In the first mode, audio signals reproduced from a reproducing device (such as the CD player 52, the tape player 54, a video cassette recorder/reproducer (VCR), a phonograph, or the like) may be supplied to the receiver/transmitter 50 by way of the appropriate one(s) of input terminals or switches 102. The received audio signals may be supplied to a processor 108 so as to be processed in a predetermined manner and amplified. The processed and amplified audio signals from the processor 108 may be supplied to an output terminal(s) 116 for supply to the speakers 56 (FIG. 2). Additionally, in the first mode, the broadcast switch 104 is in the OFF position whereupon such switch may be opened so as not to enable reproduced audio signals from the input terminals 102 to be supplied to the FM modulator 110.

In the second mode, audio signals reproduced from a reproducing device (such as the CD player 52, the tape player 54, a video cassette recorder/reproducer (VCR), a phonograph, or the like) may be supplied through the appropriate one(s) of the input terminals or switches 102 to an FM modulator 110. The FM modulator 110 may also receive a signal representative of a desired FM frequency from the frequency select dial 106. As a result, the FM modulator 110 may modulate the received audio signals with the desired FM frequency so as to form a modulated signal and may supply the same to the FM power amplifier 112 so as to be amplified. Such amplified and modulated audio signals may be broadcasted or transmitted by way of an antenna 114. Further, since the anticipated broadcast range for the audio signals is relatively small, such signals may be transmitted in a low-power manner.

The second mode may be activated by use of the on/off broadcast switch 104. In other words, to activate the second mode, an operator may place the broadcast switch 104 in the ON position whereupon such switch may be closed so as to enable reproduced audio signals from the input terminals 102 to be supplied to the FM modulator 110. In addition, in the second mode, the operator may select a desired transmission or broadcast frequency from among a number of FM frequencies by use of the frequency select dial 106, whereupon a signal representative of the same is supplied to the FM modulator 110. As a result, and in a manner as previously described, modulated audio signals may be formed and transmitted over the selected FM frequency.

Therefore, when operating in the second mode, the receiver/transmitter 50 may cause audio signals reproduced from a reproducing device (CD player, VCR, tape player, and so forth) to be transmitted over a selected FM frequency. Such transmitted audio signals may be received by a wireless receiver tuned to the selected FM frequency which may be located in a room or portion of the home or office different from the that of the receiver/transmitter 50. For example, and with reference to FIG. 2, such transmitted audio signals may be received by: (i) a relatively small-type portable radio 82 (such as a DC powered type portable radio) adaptable to be easily carried by a user and which may have headphones 83; (ii) a larger type portable radio 84 which may be DC or AC/DC powered; and/or (iii) an AC powered radio 86 (such as a clock-type radio), each of which being located in a different room or portion of the home or office from the receiver/transmitter 50.

The receiver/transmitter 50 may operate in either the first or the second mode or, alternatively, may operate in both the first and second modes simultaneously. Such operation may be performed by the use of a switch 104′ which may be coupled to the on/off broadcast switch 104. That is, the switch 104′ may be arranged so as to be (i) opened when the broadcast switch 104 is placed in the ON position so as not to allow reproduced audio signals to be supplied to the processor 108, and (ii) closed when the broadcast switch is in the OFF position so as to allow reproduced audio signals to be supplied to the processor 108. In such arrangement, the receiver/transmitter 50 may operate in either the first or the second mode. Alternatively, the switch 104′ may be arranged so as to be (i) closed when the broadcast switch 104 is placed in the ON position so as to allow reproduced audio signals to be supplied to the processor 108, and (ii) closed when the broadcast switch is in the OFF position so as to allow reproduced audio signals to be supplied to the processor 108. In such arrangement, the receiver/transmitter 50 may operate in either the first mode (when the broadcast switch is in the OFF position) or in both the first and second modes simultaneously (when the broadcast switch is in the ON position).

Thus, the present invention provides a receiver/transmitter apparatus for use in an audio system located in a home or office which may operate in a number of modes in which one of such modes enables reproduced audio signals to be transmitted over a selected frequency for reception by a wireless receiver tuned to the selected frequency and located in a different location of the home or office (or in close proximity thereto) from that of the receiver/transmitter. As a result, the present receiver/transmitter apparatus enables an operator to listen to a desired portion of a compact disc or tape or the like which is being reproduced by a reproducing device located in a first location of a home or office while the operator is in a different room or portion of the home or office or while the operator is moving between rooms or portions of the home or office.

Although the present receiver/transmitter was described as transmitting audio signals over a FM frequency selected from among a number of FM frequencies, the present invention is not so limited and may instead transmit audio signals over other frequencies. For example, the present receiver/transmitter may transmit audio signals over an AM (amplitude modulated) frequency selected from among a number of AM frequencies. Alternatively, the present receiver/transmitter may transmit audio signals over a predetermined frequency.

Although preferred embodiments of the present invention and modifications thereof have been described in detail herein, it is to be understood that this invention is not limited to these embodiments and modifications, and that other modifications and variations may be effected by one skilled in the art without departing from the spirit and scope of the invention as defined by the appended claims.

What is claimed is:

1. An audio system for use in a home or office, said audio system comprising:
means, located in a first location of said home or office, for producing an audio signal; and
means, including means for selecting a desired broadcasting frequency from among a number of broadcast frequencies, for broadcasting said audio signal over the selected broadcasting frequency for reception by a receiving device located in a second location of said home or office.

2. An audio system according to claim 1, wherein the receiving device is a portable-type radio receiver.

3. An audio system according to claim 1, wherein the number of broadcast frequencies include a number of frequency modulated (FM) frequencies.

4. An audio system for use in a home or office, said audio system comprising:
a reproducing unit, located in a first location of said home or office, for reproducing audio signals from a storage medium; and
a receiver/transmitter unit coupled to said reproducing unit and having means for enabling an operator to select a desired broadcasting frequency from among a number of broadcast frequencies, said receiver/transmitter unit receives the reproduced audio signals from said reproducing unit and broadcasts audio signals corresponding thereto over the selected broadcasting frequency for reception by a second receiver unit located in a second location of said home or office.

5. An audio system according to claim 4, wherein said reproducing unit is any of a compact disc player, a cassette tape player, and a phonograph and wherein said storage medium is a corresponding one of a compact disc, a tape, and a record.

6. An audio system according to claim 4, wherein said second receiver unit is a portable-type receiver adaptable to be carried by an operator.

7. An audio system according to claim 4, wherein the number of broadcast frequencies include frequency modulated (FM) frequencies.

8. An apparatus for use in an audio system located in a first location of a home or office, said audio system having at least one of a compact disc player, a tape player, and a phonograph for providing reproduced audio signals, said apparatus comprising:
means for enabling an operator to select a desired broadcasting frequency from among a number of broadcast frequencies; and
a transmitter circuit for receiving the reproduced audio signals from said compact disc player or said tape player or said phonograph, for processing the received audio signals, and for broadcasting the processed audio signals over the selected broadcasting frequency so as to be received by a remote receiver unit located in a second location of said home or office.

9. An apparatus according to claim 8, wherein said transmitter circuit includes a modulator for modulating the received audio signals with the selected broadcasting frequency so as to form modulated audio signals and an amplifier for amplifying the modulated audio signals.

10. An apparatus according to claim 9, wherein the number of broadcast frequencies include frequency modulated (FM) frequencies and wherein said modulator is a FM-type modulator.

11. An apparatus according to claim 10, wherein said remote receiver unit is a portable-type receiver adaptable to be carried by the operator.

12. An apparatus for use in an audio system having a reproducing device for providing reproduced audio signals and located in a first location of a home or office, said apparatus comprising a transmitter circuit and being operable in a number of modes in which in one of said modes said transmitter circuit receives the reproduced audio signals from said reproducing device, processes the received audio signals, and broadcasts the processed audio signals over a broadcasting frequency so as to be received by a remote receiver unit located in a second location of said home or office.

13. An apparatus according to claim 12, wherein said transmitter circuit includes a modulator for modulating the received audio signals with the broadcasting frequency so as to form modulated audio signals and an amplifier for amplifying the modulated audio signals.

14. An apparatus according to claim 13, wherein the broadcasting frequency is a frequency modulated (FM) frequency and wherein said modulator is a FM-type modulator.

15. An apparatus according to claim 14, wherein said remote receiver unit is a portable-type receiver adaptable to be carried by the operator.
